(19) United States
(12) Patent Application Publication
(10) Pub. No.: US 2008/0134843 A1
(43) Pub. Date: Jun. 12, 2008

(54) Socket receiver for an adjustable wrench assembly

(76) Inventor: Timothy J. Smith, Loomis, CA (US)

Correspondence Address: James P. Broder;Roeder & Broder LLP, 10680 Treena Street, Suite 100, San Diego, CA, 92131, US

(21) Appl. No.: 11/985,482

(22) Filed: Nov. 15, 2007

Related U.S. Application Data
(60) Provisional application No. 60/859,461, filed on Nov. 15, 2006.

(51) Int. Cl. B25B 13/06; B25B 13/46

(52) U.S. Cl. 81/121.1; 81/60

(57) ABSTRACT

A socket receiver for a wrench assembly that is used with a socket having a longitudinal axis includes a receiver body and a socket retainer. The receiver body selectively receives the socket. The receiver body can include a proximal section, a distal section and a body aperture. The proximal section is shaped to inhibit the socket from rotating relative to the receiver body. The distal section is positioned so that the proximal section is between the distal section and the wrench body. The distal section is shaped so that the distal section does not inhibit the socket from rotating relative to the receiver body. The body aperture extends continuously through the proximal section and the distal section. In some embodiments, the socket retainer can encircle the receiver body. The socket retainer engages the socket to inhibit movement of the socket relative to the receiver body in a direction substantially along the longitudinal axis. The socket retainer is positioned substantially between the proximal section and the distal section. The distal section can have a circular shape and the proximal section can have a square shape. The socket retainer can include an O-ring formed from a rubberized material.

### RELATED APPLICATION

This application claims domestic priority under 35 U.S.C. § 119(e) from U.S. Provisional Patent Application Ser. No. 60/859,461, filed Nov. 15, 2006, the entire contents of which are expressly incorporated herein by reference to the extent permitted.

### BACKGROUND

Many of today's combustion engines include a plurality of valves that require various adjustments for better performance. It is desirable to mechanically adjust an adjustment screw and a locking nut on each valve with a wrench assembly, known in the industry as a valve lash adjuster, to obtain more efficient fuel burning and appropriate pressure in the combustion chambers of the engine. Conventional valve lash adjusters have been used for decades. However, these conventional valve lash adjusters have certain drawbacks. For example, because of the typical confined space within which to work on the valves, it is difficult and/or cumbersome to coordinate the sequential adjustment of both the adjustment screw and the locking nut. In addition, these types of valve lash adjusters can require thinner-walled materials and can therefore be relatively fragile and more susceptible to torque-induced breakage.

### SUMMARY

One embodiment of the present invention is directed toward a socket receiver for a wrench assembly that is used with a socket having a longitudinal axis. The wrench assembly includes an adjuster and a wrench body. In certain embodiments, the socket receiver includes a receiver body and a socket retainer. The receiver body can selectively receive the socket. In one embodiment, the receiver body includes a proximal section, a distal section and a body aperture. The proximal section can be shaped to inhibit the socket from rotating relative to the receiver body. The distal section can be positioned so that the proximal section is between the distal section and the wrench body. Further, the distal section can be shaped so that the distal section does not inhibit the socket from rotating relative to the receiver body. The body aperture can extend continuously through the proximal section and the distal section so that a portion of the adjuster can extend through the receiver body. In some embodiments, the socket retainer substantially encircles the receiver body. The socket retainer can engage the socket to inhibit movement of the socket relative to the receiver body in a direction substantially along the longitudinal axis.

In one embodiment, the socket retainer is positioned substantially between the proximal section and the distal section. In another embodiment, the receiver body is formed integrally with the wrench body. In an alternative embodiment, the receiver body can include a ratchet mechanism that engages with the wrench body so that the socket rotates in a ratcheting manner. The distal section can have a substantially circular cross-sectional shape. In certain embodiments, the proximal section can have a substantially square cross-sectional shape. The socket retainer can be formed from a resilient material such as an O-ring formed from a rubberized material.

The present invention is also directed toward a wrench assembly. The wrench assembly can include a socket receiver such as that described above and a handle coupled to the socket receiver.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a perspective view of one embodiment of an adjustable wrench assembly having features of the present invention;

FIG. 2 is an exploded view of another embodiment of the adjustable wrench assembly;

FIG. 3 is a perspective view of one embodiment of a socket and an adjustable wrench assembly including a socket receiver;

FIG. 4 is a detailed view of an embodiment of a portion of the adjustable wrench assembly;

FIG. 5 is a detailed view of an embodiment of a portion of the adjustable wrench assembly including a socket retainer;

FIG. 6 is a detailed view of the portion of the adjustable wrench assembly illustrated in FIG. 5 with the socket retainer removed;

FIG. 7A is a cross-sectional view of a portion of the adjustable wrench assembly taken on line 7A-7A in FIG. 5 including a socket receiver and a socket retainer;

FIG. 7B is a top view of the socket receiver illustrated in FIG. 7A with the socket retainer omitted;

FIG. 7C is a cross-sectional view of the portion of the adjustable wrench assembly illustrated in FIG. 7A with a socket positioned on the socket receiver;

FIG. 8A is a cross-sectional view of a portion of another embodiment of the adjustable wrench assembly including the socket retainer; and

FIG. 8B is a top view of the socket receiver illustrated in FIG. 8A with the socket retainer omitted.

### DESCRIPTION

The present invention is directed toward a socket receiver for an adjustable wrench assembly (also sometimes referred to herein as a “wrench assembly”) that adjusts a plurality of tighteners or other threaded parts.

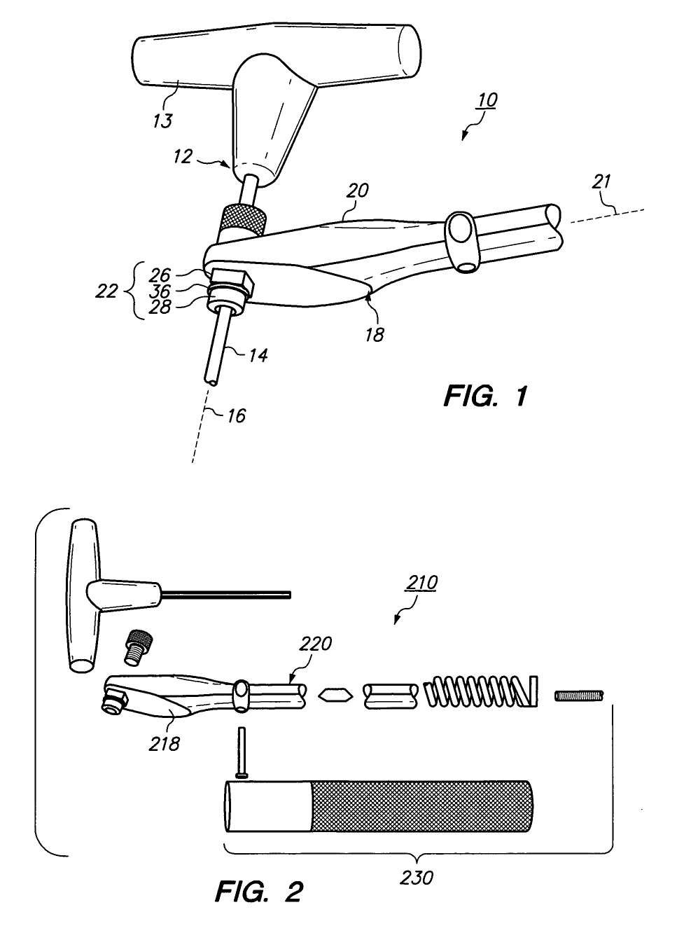

FIG. 1 is a perspective view of one embodiment of an adjustable wrench assembly 10. In one embodiment, the wrench assembly 10 can be used to adjust both a valve lash screw (not shown) and a rocker arm nut (not shown) without the need for using two separate tools or having to switch one tool for another in order to adjust a plurality of different tighteners. In various non-exclusive embodiments, the wrench assembly 10 can be used with engines for automobiles or other machines, such as those used in high performance racing, motorcycles and/or other types of motorized vehicles. Alternatively, the wrench assembly 10 can be used for other suitable mechanical assemblies requiring adjustment of multiple screws, bolts, pins, nuts, etc. For ease of discussion, the embodiments shown and described herein pertain particularly to adjustment performed to the valve lash of an engine, although it is recognized that the wrench assembly 10 can be used for numerous other purposes that require adjustment of multiple parts of an assembly.

In the embodiment illustrated in FIG. 1, the wrench assembly 10 can have one or more basic functions. For example, a first adjuster 12 adjusts a valve lash screw (not shown). A handle 13 is secured to a first adjuster member 14 that extends from the handle 13. In one embodiment, the handle 13 can be T-shaped or can have another suitable shape. The handle 13 is rotated about an axis 16 (also referred to herein as a “socket axis” or a “longitudinal axis”) to loosen, tighten or otherwise position the valve lash screw (or other suitable part) to achieve the desired valve lash and/or positioning of the part. The first adjuster member 14 engages the screw or other part to be adjusted. The first adjuster member 14 can have any configuration necessary to adjust the screw or other part to be adjusted. For example, the first adjuster member 14 can be a slotted screwdriver, a hex key, can have an “X” configuration, a star configuration, or any other suitable shape.

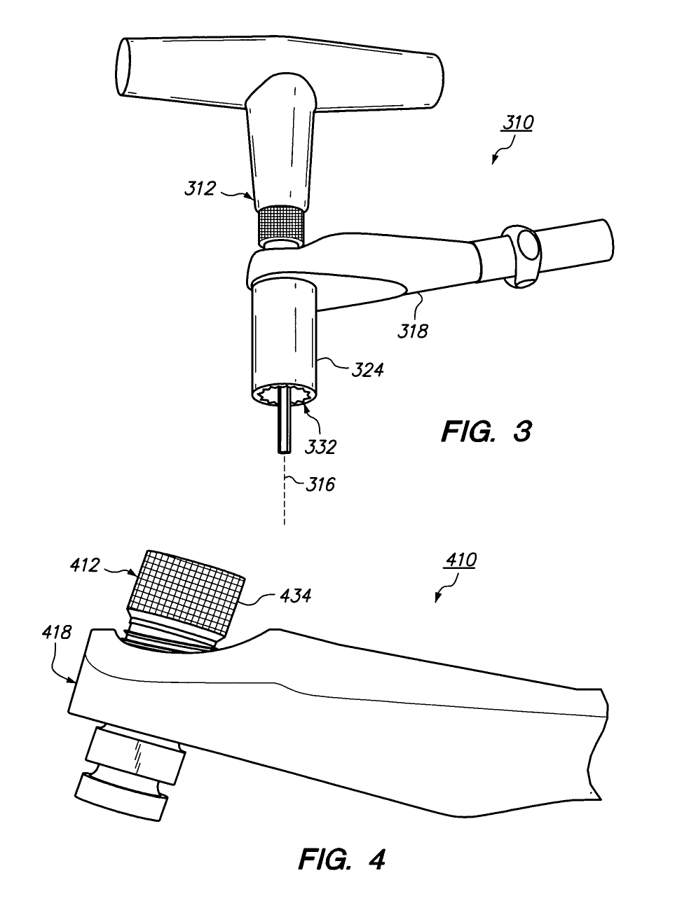

Additionally, a second adjuster 18 can be used to adjust an adjuster nut (not shown). In one embodiment, the adjuster nut can tighten down against a rocker arm (not shown). In certain embodiments, the second adjuster 18 can include a wrench body 20, a socket receiver 22 and a socket 324 (illustrated in FIG. 3) that is rotated about the axis 16 to adjust the tightness of the adjuster nut. The wrench body 20 has a wrench body axis 21 that can extend away from the axis 16 of the first adjuster member 14 at an angle of at least 90 degrees. In non-exclusive alternative embodiments, the angle between the axis 16 and the wrench body axis 21 can be at least approximately 95 degrees, 100 degrees, 105 degrees, 110 degrees, 120 degrees or 135 degrees.

The socket receiver 22 receives the socket 324. In the embodiment illustrated in FIG. 1, the socket receiver 22 is fixed relative to the wrench body 20. In an alternative embodiment, the socket receiver 22 can rotate relative to the wrench body 20, such as in a ratcheting manner or some other suitable manner known to those skilled in the art. The socket receiver 22 can be configured to have any suitable width dimensions, i.e. ¼ inch, ⅜ inch, ½ inch, etc., as non-exclusive examples, although it is recognized that the width dimensions of the socket receiver 22 can be larger or smaller than the foregoing examples.

In certain embodiments, the socket receiver 22 includes a proximal section 26, a distal section 28 and a socket retainer 36. In the embodiment illustrated in FIG. 1, the proximal section 26 is positioned more proximate the handle 20 than the distal section 28. In an alternative embodiment (not shown), the proximal section 26 can be positioned further from the handle 20 than the distal section 28. In the embodiment illustrated in FIG. 1, the proximal section 26 is secured to the handle 20. In certain embodiments, the proximal section 26 can be formed integrally with the handle 20.

The proximal section 26 has a configuration that can be similar to and interlocking with a female section of the socket 324 so that rotation of the proximal section 26 directly results in rotation of the socket 324. For example, in the embodiment illustrated in FIG. 1, a cross-section of the proximal section 26 has a substantially square shape, and would receive a similarly shaped four-sided socket 324, for example. Alternatively, the proximal section 26 can have a different shaped cross-section that would receive an appropriately-shaped socket 324. Still alternatively, the cross-sectional shape of the proximal section 26 can be different than that of the socket 324, provided the purposes of the proximal section 26 as described herein are utilized. In certain embodiments, the proximal section 26 is a bearing element. As used herein, the bearing element exerts a rotational force (torque) on the socket 324 in order to tighten or loosen the adjuster nut. Additionally, the proximal section 26 inhibits movement of the socket 324 relative to the proximal section 26 and/or the remainder of the socket receiver 22.

In certain embodiments, such as the embodiment illustrated in FIG. 1, for example, the distal section 28 has a different cross-sectional configuration than the proximal section 26. In the embodiment shown in the Figures, a cross-section of the distal section 28 is substantially circular. With this design, the distal section 28 is not a bearing element to the extent that the distal section 28 does not exert a rotational force (torque) on the socket 324 during tightening or loosening of the adjuster nut. Stated another way, without engagement between the socket 324 and the proximal section 26, the distal section 28 could simply rotate or spin within the socket 324 without causing any substantial rotation of the socket 324.

As explained in greater detail below, because the distal section 28 is a non-bearing element as described herein, the likelihood of fracturing the socket receiver 22 is decreased. Consequently, the lifetime of the wrench assembly 10 is increased, as is the reliability and robustness of the wrench assembly 10.

In the embodiment illustrated in FIG. 1, the socket retainer 36 is positioned substantially between the proximal section 26 and the distal section 28. As explained in greater detail below, the socket retainer 36 retains the socket 324 on the socket receiver 22 so that the socket 324 is inhibited from unwanted movement in a direction substantially along the longitudinal axis 16.

FIG. 2 shows an exploded view of another embodiment of the adjustable wrench assembly 210. In this embodiment, the wrench body 220 can include an extension assembly 230 that extends the length of the wrench body 220 to increase leverage of the second adjuster 218 during rotation. In another embodiment, the second adjuster 218 can include a torque wrench (not shown) so that the torque of the adjuster nut can be set without having to use a separate torque wrench tool that can otherwise interrupt the adjustment process.

FIG. 3 is a perspective view of one embodiment of the adjustable wrench assembly 310 and a socket 324 positioned on the adjustable wrench assembly 310. The socket 324 has a longitudinal axis 316 (also referred to as a “socket axis”), which in this embodiment, is substantially similar or identical to the axis 16 (illustrated in FIG. 1). In this embodiment, the socket 324 can be a standard socket having a four-sided wrench engager (not shown) that engages the socket receiver 22 (obscured by socket 324 in FIG. 3; illustrated in FIG. 1). Alternatively, the socket 324 can have a wrench engager that has greater or fewer than four sides for engagement with the socket receiver 22. Further, the socket 324 can include a nut engager 332 that is opposite the wrench engager. The nut engager 332 can be four-, five-, six-, eight- or twelve-sided (as non-exclusive examples), and can fit over and/or engage the adjuster nut to be adjusted.

In various embodiments, the socket 324 is removable and can be replaced with a different sized socket 324, as explained in greater detail below. Thus, the user can adjust the valve lash screw (or bolt) using the first adjuster 312, then tighten (or loosen) the adjuster nut with the second adjuster 318, all without having to change tools or release the tool from the user's hands. With this design, the need for two separate tools is obviated, which saves time and increases ease, accuracy and efficiency.

FIG. 4 is a detailed side view of a portion of the adjustable wrench assembly 410. In FIG. 4, a portion of the first adjuster 12 (illustrated in FIG. 1) has been omitted for clarity. In this embodiment, the adjustable wrench assembly 410 includes a first adjuster 412 and a second adjuster 418. The first adjuster 412 includes a bushing 434 that receives the first adjuster member 14 (illustrated in FIG. 1). The bushing 434 can be removably secured to the second adjuster 418. For example, the bushing 434 can be threadedly secured to the second adjuster 418. Alternatively, the bushing 434 can be removably secured to the second adjuster 418 by another suitable means. In certain embodiments, the bushing 434 can be removed and replaced with another bushing 434 of a different size. In other words, the first adjuster 412 can be adjusted to accommodate first adjuster members 14 of different widths or sizes. Thus, the bushing 434 can be changed out so that a relatively snug fit is achieved between the first adjuster member 14 and the bushing 434 in order to stabilize the first adjuster member 14 during use, and to assist in positioning and/or centering the first adjuster member 14 relative to the valve lash screw. The bushing 434 can be formed from any suitable material, such as metal, plastic, ceramic or another suitably rigid material.

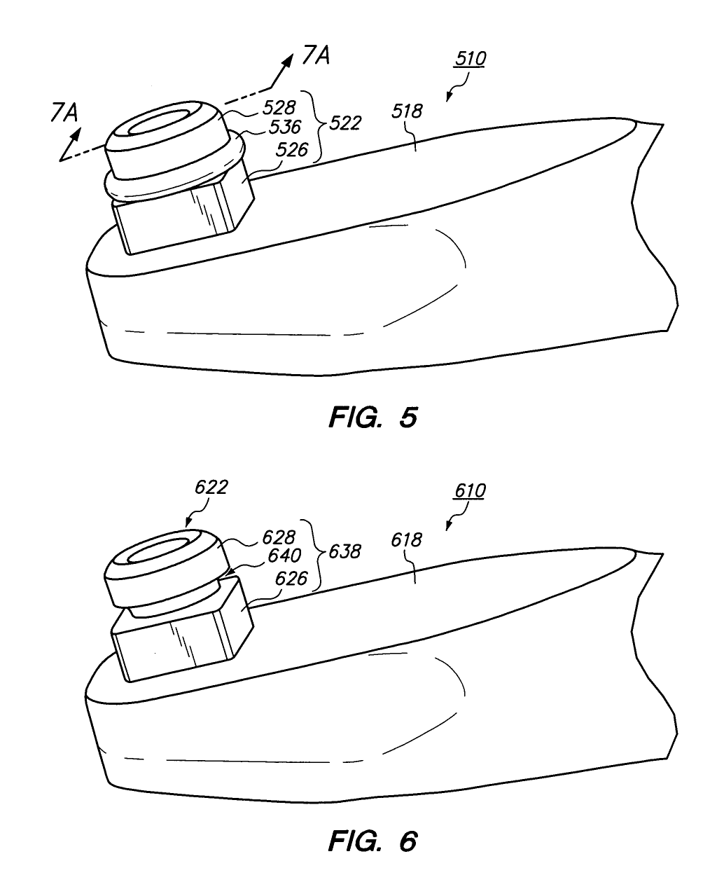

FIG. 5 is a detailed perspective view of a portion the adjustable wrench assembly 510 including a portion of the second adjuster 518. In this embodiment, the second adjuster 518 includes the socket receiver 522. In certain embodiments, the socket receiver 522 includes the proximal section 526, the distal section 528 and a socket retainer 536 positioned substantially between the proximal section 526 and the distal section 528. In one embodiment, the socket retainer 536 includes a resilient material, such as a rubberized O-ring in one non-exclusive embodiment, which selectively retains the socket 324 (illustrated in FIG. 3) and inhibits the socket 324 from becoming disengaged from the second adjuster 518. Stated another way, the socket retainer 536 inhibits movement of the socket 324 in a direction along the longitudinal axis 316 (illustrated in FIG. 3). The O-ring can alternatively be formed from another suitable material, such as plastic, acrylic, metal, silicon, other synthetic materials, etc. Alternatively, the socket retainer 536 can utilize another suitable mechanism for retaining the socket 324.

FIG. 6 is a detailed perspective view of a portion the adjustable wrench assembly 610 including a portion of the second adjuster 618. In this embodiment, the second adjuster 618 includes the socket receiver 622. In the embodiment illustrated in FIG. 6, the socket receiver includes a receiver body 638. The receiver body 638 includes the proximal section 626, the distal section 628 and a retainer recess 640. In FIG. 6, the socket retainer 536 (illustrated in FIG. 5) has been omitted for ease of discussion. In this embodiment, the retainer recess 640 extends partially or fully around the socket receiver 622, and has a reduced dimension between the proximal section 626 and the distal section 628 to better accommodate and retain the socket retainer 536. Absent the features of the present invention, this reduced dimension could otherwise be a potential fracture location during tightening or loosening of the adjuster nut with the second adjuster 618. However, because the distal section 628 of the socket receiver 622 is a non-bearing element as described previously herein, the likelihood of a fracture between the proximal section 626 and the distal section 628 is substantially decreased or eliminated.

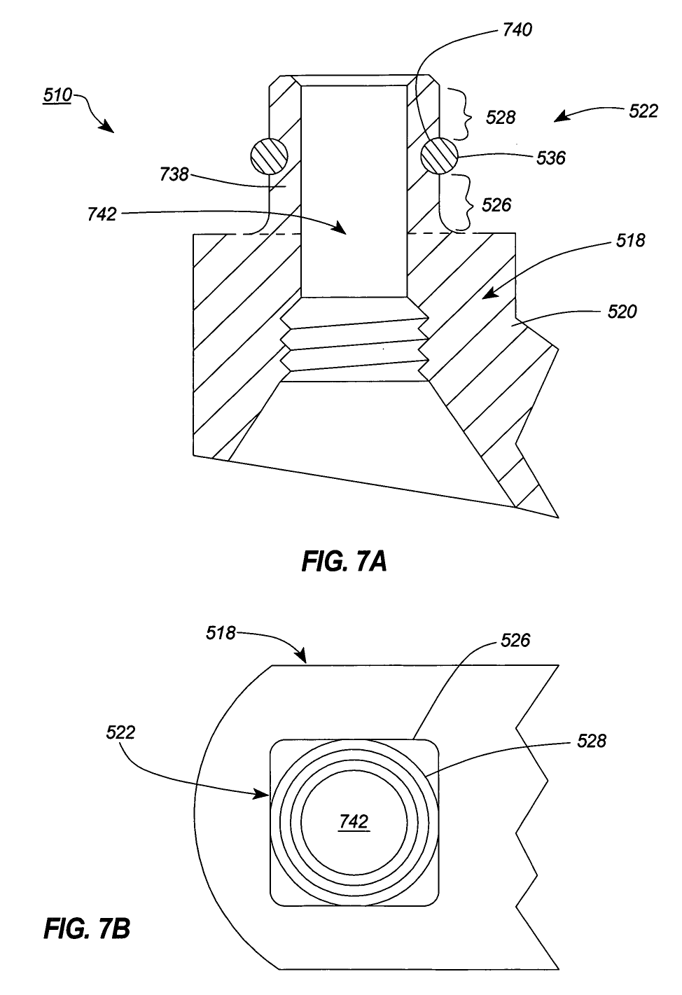

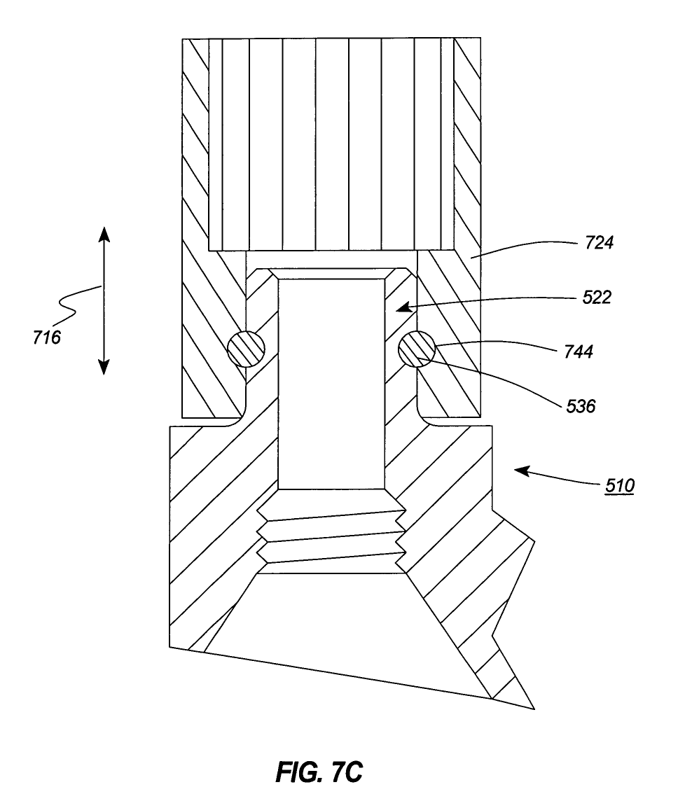

FIG. 7A is a cross-sectional view of a portion of the adjustable wrench assembly 510 taken on line 7A-7A in FIG. 5 including a portion of the second adjuster 518. In this embodiment, the second adjuster 518 includes the socket receiver 522. The socket receiver 522 includes a receiver body 738 and the socket retainer 536. The receiver body 738 includes the proximal section 526, the distal section 528 and a retainer recess 740 that retains the socket retainer 536. In this embodiment, the receiver body 738 also includes a body aperture 742 that extends continuously through the receiver body 738.

The size and/or shape of the body aperture 742 can vary depending upon the design requirements of the first adjuster member 14 (illustrated in FIG. 1) and/or the wrench assembly 510. With one or more of the designs provided herein, the socket retainer 536 and/or the retainer recess 740 do not unduly limit the diameter of the body aperture 742. Thus, the size of the body aperture 742 can be increased to allow a greater variance in the size and/or shape of the first adjuster member 14. The body aperture 742 allows at least a portion of the first adjuster member 14 of the first adjuster 12 (illustrated in FIG. 1) to extend through the receiver body 738.

In the embodiment illustrated in FIG. 7A, the receiver body 738 is integrally formed with the wrench body 520 of the second adjuster 518. In an alternative embodiment, the receiver body 738 can be formed separately (as illustrated by dashed line in FIG. 7A) from the wrench body 520 and subsequently secured to the wrench body 520 by any suitable means.

FIG. 7B is a top view of the portion of the second adjuster 518 including the socket receiver 522 illustrated in FIG. 7A with the socket retainer 536 (illustrated in FIG. 7A) omitted for clarity. In this embodiment, FIG. 7B illustrates that the proximal section 526 has a substantially square shape (perimeter), while the distal section 528 has a substantially circular shape (perimeter). With this design, movement of the distal section 528 does not directly influence or exert a force on the socket 324 (illustrated in FIG. 3). Somewhat similarly, movement of the socket 324 (by moving the proximal section 526, for example) does not directly influence or exert a force on the distal section 528. This design inhibits breakage of socket receiver 522 at or near the retainer recess 740 (illustrated in FIG. 7A), which may be the thinnest-walled region of the socket receiver 522.

FIG. 7C is a cross-sectional view of the portion of the adjustable wrench assembly 510 illustrated in FIG. 7A with a socket 724 positioned on the socket receiver 522. In this embodiment, the socket 724 is retained by the socket retainer 536. The socket retainer 536 is positioned so that a detent 744 in the socket 724 engages the socket retainer 536 to inhibit unwanted movement of the socket 724 in a direction (illustrated by arrow 716) along the longitudinal axis 316 (illustrated in FIG. 3). However, a user can exert a force sufficient to overcome the retention of the socket 724 by the socket retainer 536 in order to remove the socket 724 from the socket receiver 522.

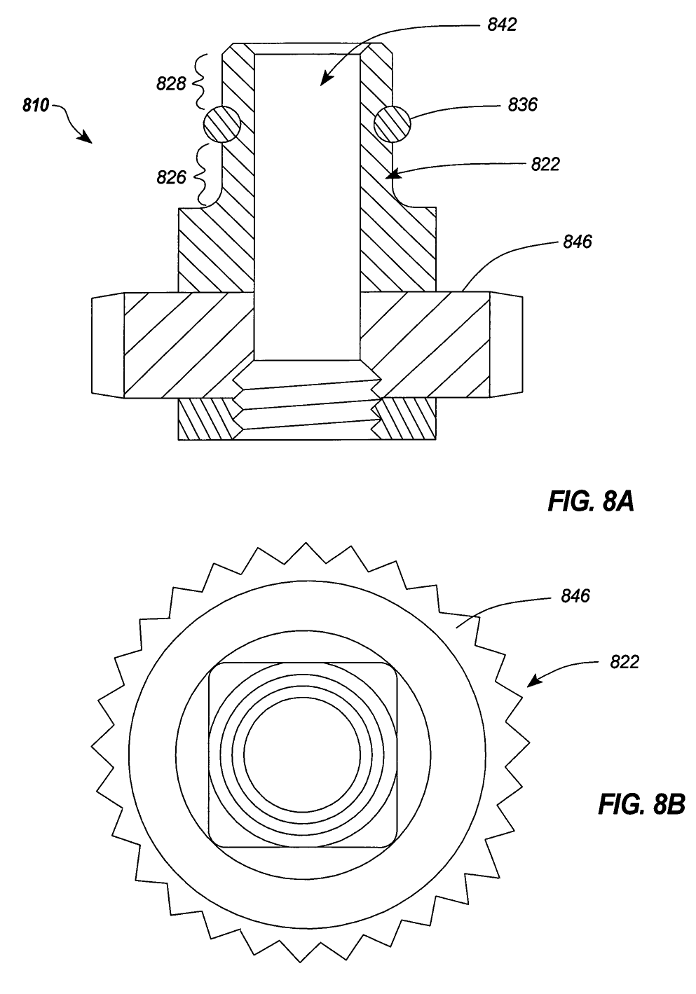

FIG. 8A is a cross-sectional view of a portion of another embodiment of the adjustable wrench assembly 810. In the embodiment illustrated in FIG. 8A, the adjustable wrench assembly 810 includes a socket receiver 822 that includes a proximal section 826, a distal section 828, a socket retainer 836 and a ratchet mechanism 846. In certain embodiments, the ratchet mechanism 846 engages with the wrench body 20 (illustrated in FIG. 1) so that the socket can rotate in a ratcheting manner. In other words, the socket receiver 822 can rotate in a ratcheting manner relative to the wrench body 20, and can operate in a somewhat similar manner as a standard ratcheting wrench. In the embodiment illustrated in FIG. 8A, the socket receiver 822 includes a body aperture 842 that receives at least a portion of the first adjuster member 14 (illustrated in FIG. 1) so that the wrench assembly 810 can operate in a substantially similar manner as previously described herein.

FIG. 8B is a top view of the socket receiver 822 illustrated in FIG. 8A with the socket retainer 836 omitted for clarity. It is recognized that although the wrench body 20 (illustrated in FIG. 1) is not illustrated in FIG. 8B, the ratcheting mechanism 846 engages with a gear system (not shown) included in the wrench body 20 and operates as understood by those skilled in the art. It is recognized that the ratcheting mechanism 846 illustrated in FIG. 8B is representative of one type of ratcheting mechanism, and is not intended to be limiting in any manner.

While the particular adjustable wrench assembly 10 as shown and disclosed herein is fully capable of obtaining the objects and providing the advantages herein before stated, it is to be understood that it is merely illustrative of the presently preferred embodiments of the invention and that no limitations are intended to the details of the methods, construction or design herein shown and described.

What is claimed is:

1. A socket receiver for a wrench assembly that is used with a socket having a longitudinal axis, the wrench assembly including an adjuster and a wrench body, the socket receiver comprising:
a receiver body that selectively receives the socket, the receiver body including (i) a proximal section that is shaped to inhibit the socket from rotating relative to the receiver body, (ii) a distal section positioned so that the proximal section is between the distal section and the wrench body, the distal section being shaped so that the distal section does not inhibit the socket from rotating relative to the receiver body, and (iii) a body aperture that extends continuously through the proximal section and the distal section so that a portion of the adjuster can extend through the receiver body; and
a socket retainer that substantially encircles the receiver body, the socket retainer engaging the socket to inhibit movement of the socket relative to the receiver body in a direction substantially along the longitudinal axis.

2. The socket receiver of claim 1 wherein the socket retainer is positioned substantially between the proximal section and the distal section.

3. The socket receiver of claim 1 wherein the receiver body is formed integrally with the wrench body.

4. The socket receiver of claim 1 wherein the receiver body includes a ratchet mechanism that engages with the wrench body so that the socket rotates in a ratcheting manner.

5. The socket receiver of claim 1 wherein the adjuster is adapted to adjust the positioning of a screw.

6. The socket receiver of claim 1 wherein the distal section has a substantially circular cross-sectional shape.

7. The socket receiver of claim 6 wherein the proximal section has a substantially square cross-sectional shape.

8. The socket receiver of claim 7 wherein the socket retainer is positioned substantially between the proximal section and the distal section.

9. The socket receiver of claim 1 wherein the socket retainer is formed from a resilient material.

10. The socket receiver of claim 1 wherein the socket retainer includes a O-ring formed from a rubberized material.

11. A wrench assembly including the socket receiver of claim 1 and a wrench body coupled to the socket receiver.

12. A socket receiver for a wrench assembly that is used with a socket having a longitudinal axis, the wrench assembly including a wrench body, the socket being adapted for rotation with the handle about the longitudinal axis, the socket receiver comprising:
a receiver body that is coupled to the wrench body, the receiver body including (i) a proximal section that selectively receives the socket, the proximal section being shaped so that the socket is inhibited from rotating relative to the receiver body, (ii) a distal section positioned away from the wrench body relative to the proximal section, the distal section being shaped so that the distal section does not inhibit the socket from rotating relative to the receiver body, and (iii) a retainer recess that extends at least partially around the receiver body substantially between the proximal section and the distal section; and
a socket retainer that is formed from a resilient material and is at least partially positioned within the retainer recess, the socket retainer inhibiting movement of the socket relative to the receiver body in a direction substantially along the longitudinal axis.

13. The socket receiver of claim 12 further comprising a body aperture that extends continuously through the proximal section and the distal section.

14. The socket receiver of claim 13 wherein the wrench assembly includes an adjuster that extends through the body aperture to adjust the positioning of a screw.

15. The socket receiver of claim 12 wherein the receiver body is formed integrally with the wrench body.

16. The socket receiver of claim 12 wherein the receiver body includes a ratchet mechanism so that the socket rotates in a ratcheting manner.

17. The socket receiver of claim 12 wherein the distal section has a substantially circular cross-sectional shape.

18. The socket receiver of claim 17 wherein the proximal section has a substantially square cross-sectional shape.

19. The socket receiver of claim 12 wherein the resilient material includes a rubberized O-ring.

20. A wrench assembly including the socket receiver of claim 12 and a wrench body coupled to the socket receiver.

21. A wrench assembly that is used with a socket, the wrench assembly comprising:
a wrench body;
an adjuster for adjusting the positioning of a screw;
a receiver body that selectively receives the socket, the receiver body including (i) a proximal section positioned adjacent to the wrench body, the proximal section inhibiting the socket from rotating relative to the receiver body, (ii) a distal section positioned so that the proximal section is between the distal section and the wrench body, the distal section being shaped so that the distal section does not inhibit the socket from rotating relative to the receiver body, and (iii) a body aperture that extends continuously through the proximal section and the distal section so that a portion of the adjuster extends through the receiver body; and
a socket retainer that substantially encircles the receiver body and is positioned substantially between the proximal section and the distal section, the socket retainer engaging the socket to inhibit movement of the socket relative to the receiver body in a direction substantially along the longitudinal axis.

22. The socket receiver of claim 21 wherein the receiver body is formed integrally with the wrench body.

23. The socket receiver of claim 21 wherein the receiver body includes a ratchet mechanism that engages with the wrench body so that the socket rotates in a ratcheting manner.

24. The socket receiver of claim 21 wherein the distal section has a substantially circular cross-sectional shape.

25. The socket receiver of claim 21 wherein the receiver body includes a retainer recess that is positioned around a circumference of the receiver body, the socket retainer being positioned at least partially within the retainer recess, and wherein the socket retainer includes an O-ring formed from a rubberized material.
